(19) United States
(12) Patent Application Publication
(10) Pub. No.: US 2010/0038898 A1
(43) Pub. Date: Feb. 18, 2010

(54) Insulated double-walled well completion tubing for high temperature use

(76) Inventors: Pierre Ollier, Boulogne-Billancourt (FR); Philippe Marchal, Vaucresson (FR)

Correspondence Address: STEPTOE & JOHNSON LLP, 1330 CONNECTICUT AVENUE, N.W., WASHINGTON, DC, 20036, US

(21) Appl. No.: 12/461,548

(22) Filed: Aug. 14, 2009

Related U.S. Application Data
(60) Provisional application No. 61/136,153, filed on Aug. 14, 2008.

(51) Int. Cl. F16L 55/00; B23P 11/00

(52) U.S. Cl. 285/47; 29/469

(57) ABSTRACT

An insulated double-walled well completion tubing system comprising having an inner tubing, an outer tubing for insertion into a well casing; the inner tubing located within the outer tubing, with the bottom ends of the inner and outer tubings sealed together, an insulation layer in the annular volume between the inner and outer tubings, a wellhead connected to the top end of the outer tubing, a source of heated fluid connected to the wellhead, at least one sealing spacer in the annular space above the insulation layer and below the upper end of the inner tubing, for preventing fluid from passing downward through the annular volume and reaching the insulation, the wellhead enclosing a space of sufficient dimensions to accommodate the upper end of the inner tubing at any temperature thereof. In another embodiment the insulated double-walled tubing string may be a continuous, flexible string installed continuously into a well casing. The system may additionally include a vacuum pump connected to reduce pressure within the annular volume which contains the insulation. Methods for assembling such well completion systems are also disclosed.

### CROSS-REFERENCE TO RELATED APPLICATIONS

This application claims the benefit of U.S. Provisional Patent Application Ser. No. 61/136,153, filed Aug. 14, 2008, the entirety of which is incorporated by reference

herein.

### BACKGROUND

The present invention relates to well completions to achieve highly efficient thermally insulated tubings to transport high temperature fluids downhole from the surface.

As energy prices have soared the recovery of complicated hydrocarbons from reservoirs has become a challenge that energy companies wish to overcome. Any new methods to recover such fluids or materials involve the use of thermally active processes, which involve the use of highly insulated tubular conduits to send hot fluid into the areas where the hydrocarbons are stored. These hot fluids generally have thermal and/or chemical effects.

Insulated tubes are used to conduct fluids and maintain their thermodynamic properties from a location where they have been heated to a location where the hydrocarbons rest. These tubes are covered by an insulation material to reduce heat exchange between the conducted fluid and the surrounding environment.

In the oil and gas industry it is known how efficiently to insulate a pipe. The use of microporous or nanoporous insulation materials, such as those made of nanogels, aerogels, and fumed or precipitated silica, are known at the present time. Generally, these insulation materials are installed within an outer pipe because they require a certain degree of protection, and have more effective insulative properties under reduced pressure.

### BRIEF SUMMARY OF THE INVENTION

An object of the present invention is to provide a well completion design that provides a secure way to transport hot fluids from the surface to a sub-surface reservoir.

The primary characteristics of the inventive well completion system of the present invention include a double-walled tubing comprising an inner and an outer tubing with an insulation material, for use under reduced pressure, between the inner and outer tubings. A first or bottommost section of such tubing have the inner and outer walls welded together at their bottom ends. A string of such tubing sections may be connected end-to-end and installed seriatim in a well casing. The system may also include a wellhead and an expansion or travel section. The invention also comprises methods for assembling and installing the inventive well completion system.

### BRIEF DESCRIPTION OF THE DRAWINGS

Other objects and further elements of the present invention are illustrated and disclosed in the accompanying drawings, wherein:

FIG. 1 is a schematic, cross-sectional view of a first embodiment of the inventive double-walled tubular well completion system of the present invention;

FIG. 2 is a schematic, cross-sectional view of a second embodiment of the inventive double-walled tubular well completion system of the present invention including an above-ground expansion chamber below the wellhead; and

FIG. 3 is a schematic, cross-sectional view of a third embodiment of the inventive double-walled tubular well completion system of the present invention including a below-ground expansion chamber and specially insulated tubing and seals.

### DETAILED DESCRIPTION

As indicated above, primary elements of the well completion system of the present invention include a first or bottommost tubing comprised of inner and outer tubing elements which are welded together at their bottom ends. Such first tubing can be connected with a double-walled string of inner and outer tubing sections, end-to-end, with only the bottommost end of such tubing having the inner and outer tubing welded together. Thus the double-walled tubing comprises two substantially concentric strings of tubings. Generally, the tubing can be either a single length or an assembly of lengths up to thousands of meters long. At two extremes, one may insulate short, for example, six meter long sections, or continuous insulated double-walled tubes sufficiently flexible to be capable of being wound onto a spool. The diameter and pipe material depend on the application requirements. The pipe is typically, but not necessarily, a steel pipe with a diameter between one-half inch and twelve inches. One skilled in the art of well completions typically recognizes a tubing as a tubular section of about ten meters in length that can be securely attached, end-to-end, to an immediately succeeding tubular section, by means such as a threaded joint. There are threaded connections at both ends of a tubular section. Thus a string of tubings is an assembly of such tubular sections, which assembled string of tubular sections is also sometimes referred to as a tubing or a tubing string. The double-walled tubing thus comprises two substantially concentric strings of tubes each section of the inner and outer tubes, respectively, being connected to an immediately succeeding section as its concentric inner/outer tube is so connected. Thus, there is an annular space or opening between the inner and outer tubings, which space is continuous along the length of the tubing string, and is closed at the bottom end where the inner and outer tubings are welded together, as previously indicated.

For purposes of the present invention, each double-walled section or string of tubing can have insulation pre-mounted and thus attached to either the inner surface of the outer tubing or the outer surface of the inner tubing. The insulation materials may be microporous or nanoporous insulation materials, such as nanogels, aerogels, and fumed or precipitated silica. Microporous insulation of compressed silica oxide powder is preferred. These types of insulation are so effective that the insulation thickness may be reduced to a minimum. Insulation layer thicknesses in the range of about 3 to about 25 mm are suitable, and in the range of about 5 to about 12 mm more preferred. Generally, these insulation materials have more effective insulative properties under reduced pressure. The shape of such insulation is designed so that at each end junction of each of the double walls of such tubular sections there is maximum contact between the sections being joined, so that no “thermal bridge” is created between successive sections of the double-walled tubing. In the insulated double-walled well completion system of the present invention it is also desirable for the connections between adjacent sections of the inner tubing to be of substantially the same outer diameter as the outer diameter of the inner tubing itself, to facilitate relative movement of the inner tubing within the insulation carried on the inner wall of the outer tubing. Conversely, if the insulation is attached to the outer wall of the inner tubing, the connections of sections of the outer tubing should have the same inner diameter as the outer tubing itself.

The insulation material should be thermally efficient and typically will have other desirable characteristics such as exhibiting good behavior over a wide range of temperatures, from cryogenic environments and temperatures as low as −196 degrees C., to high temperature environments up to 900 degrees C. The greater the temperature differential to which the double-walled tubing string will be subjected, the more stringent the requirements to insulate that string. The insulation material should also have mechanical properties which permit that material to support some load transmitted by both the inner and outer pipes since both inner and outer pipes may bend due to temperature differentials applied thereto. The thermal conductivity of the insulating material should also be as low as possible to provide the most compact design. Additionally, the insulating material should be able to maintain its performance over a long lifetime, the typical project life of well completions being in the range of twenty to forty years. And, the insulation material should be compatible with safety and environmental requirements.

When a double-walled pipe, tubing or pipe string is used, such insulation is highly effective where there is a high temperature differential between the inner and outer pipes of the string. Insulation is considered to provide most desirable performance when the atmosphere in the annular space between the double-walled pipes is controlled, so that there is no overpressure, and the pressure in the annular space is preferably reduced to a sub-atmospheric pressure. To achieve these conditions, one skilled in the art may use techniques wherein portions of the inner and outer pipe of a double-walled pipe string are linked to each other. Where the inner and outer pipes in a double-walled tubing or string are operated at substantial temperature differentials, the inner pipe typically tends to expand while the outer pipe does not exhibit any significant change. This temperature differential may cause some stress in both the inner and outer pipes in the string. For example, the inner pipe may be in compression, while the outer pipe is under tension, both effects resulting from the temperature differential of the inner and outer pipes.

In addition to such substantial stresses, high temperatures and high temperature differentials may cause general longitudinal buckling of the inner pipe within the outer pipe so that the pipe is no longer straight but is randomly bent in spaghetti-like fashion. However, such buckling may cause significant problems if such a pipe string is bent at the region of a threaded coupling between tubular sections. Such couplings may not be designed to work under such stress loads, and in some cases leaks may occur and result in destruction of the connecting threads in a threaded coupling.

For the foregoing reasons, the present well completion system seeks to ensure maximum thermal performance for a specified outer diameter, to manage stresses generated by temperature differentials in the double-walled tubing, and to reduce costs of the entire system.

Additionally, a packer may be included at the bottom of a double-walled tubular string to anchor the tubing string within a well casing.

The system of the present invention also includes a wellhead or wellhead extension specially designed to accommodate possible relative movements of the inner and outer pipes of a double-walled tubing string subject to high temperature differentials.

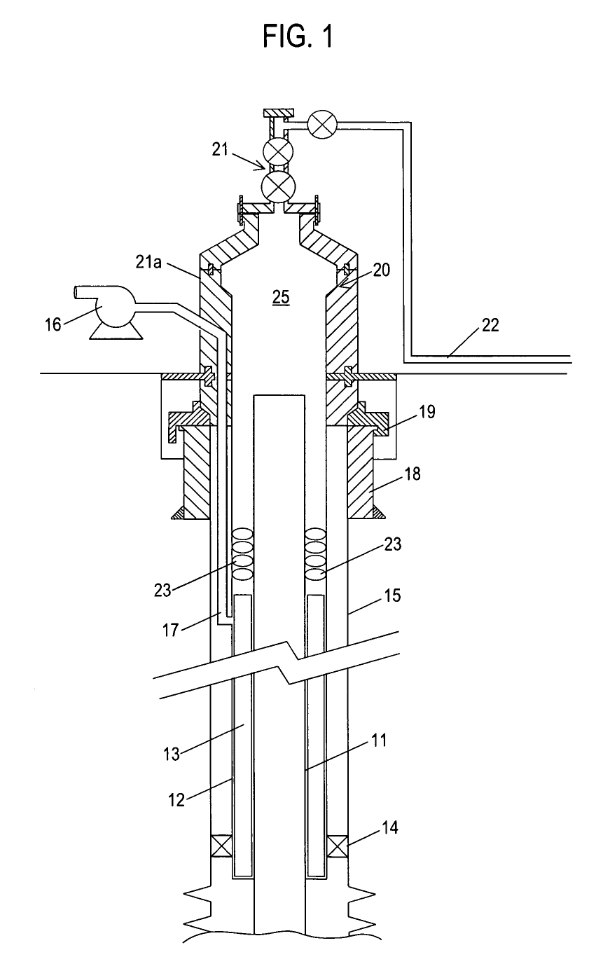

The inventive double-walled insulated tubular well completion system of the present invention is further described as illustrated in conjunction with FIGS. 1-3. As readily seen in the lower portion of FIG. 1, smaller diameter, inner tubing 11 is shown substantially coaxially or concentrically within larger diameter, outer tubing 12 which includes insulation 13 on the inner surface thereof. While insulation 13 is here shown attached to the inner wall of outer tubing 12, the insulation may alternately be attached to the outer wall of inner tubing 11. Also shown is packer 14 surrounding the exterior of the bottom of outer tube 12 at the bottom of the double-walled tubular string, thereby anchoring the tubular string within casing 15.

FIG. 1 also shows vacuum pump 16 connected via control line 17 through which the pressure within the annular space between inner tubing 11 and outer tubing 12 is controlled and preferably reduced to below atmospheric pressure to maximize performance of the insulation material therein. As illustrated in FIG. 1, the control line 17 from vacuum pump 16 enters the well completion system of the present invention through a portion of the wellhead which is shown mounted on the top of casing 15 and seated on the top ends of casing 15 and conductor tubing 18. Casing hanger 19, typically made of steel, is shown at the top of conductor tubing 18.

Wellhead 21 includes a shoulder-like casing hanger 20 in the interior surface of lower portion 21a of the wellhead, immediately below conventional wellhead 21. Through appropriate valves wellhead 21 is connected to line 22 for injection of fluids, particularly hot fluids, into the interior of the tubular string. Seals 23 within the annular space between inner tubing 11 and outer tubing 12 and above insulation 13 prevent fluid entering the wellhead from injection line 22 from passing downward into the length of the annular space between inner and outer tubings 11 and 12 which extend the length of the tubing string.

It will be appreciated in each of the embodiments illustrated in FIGS. 1-3, that the interior chamber of the wellhead has been provided with sufficient size so that the inner tubing can expand longitudinally upwardly and that such expansion can be accommodated in space 25 without contact between inner tube 11 and wellhead 21.

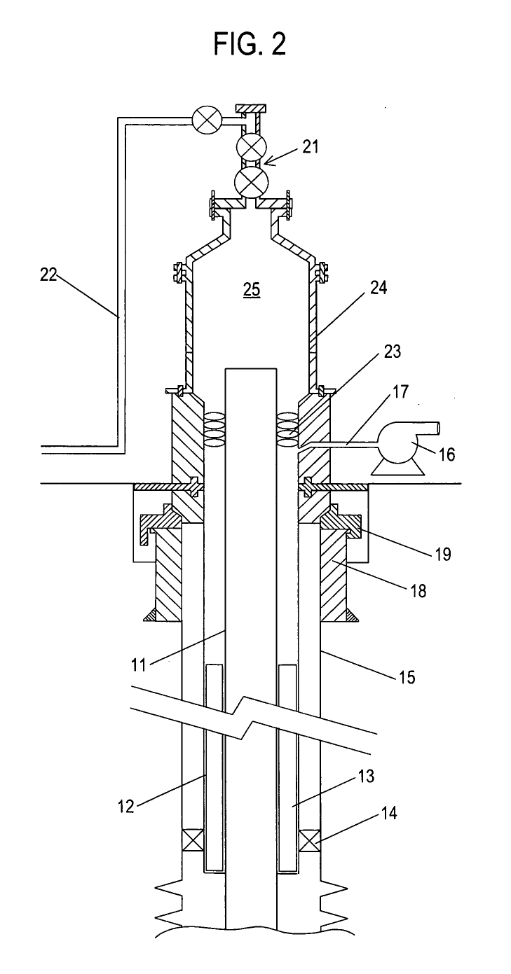

A second embodiment of the double-walled insulated tubular well completion system is illustrated in FIG. 2, which includes many of the same elements described above with respect to the embodiment illustrated in FIG. 1. In addition to the elements illustrated and described in conjunction with FIG. 1, the second embodiment of FIG. 2 includes an expansion chamber 24 just below conventional wellhead 21, and above the casing hanger 20 through which control line 17 from vacuum pump 16 enters the system. Expansion chamber 24 is typically made of steel, and extends space 25 of the wellhead to better accommodate expansion of the inner tubing.

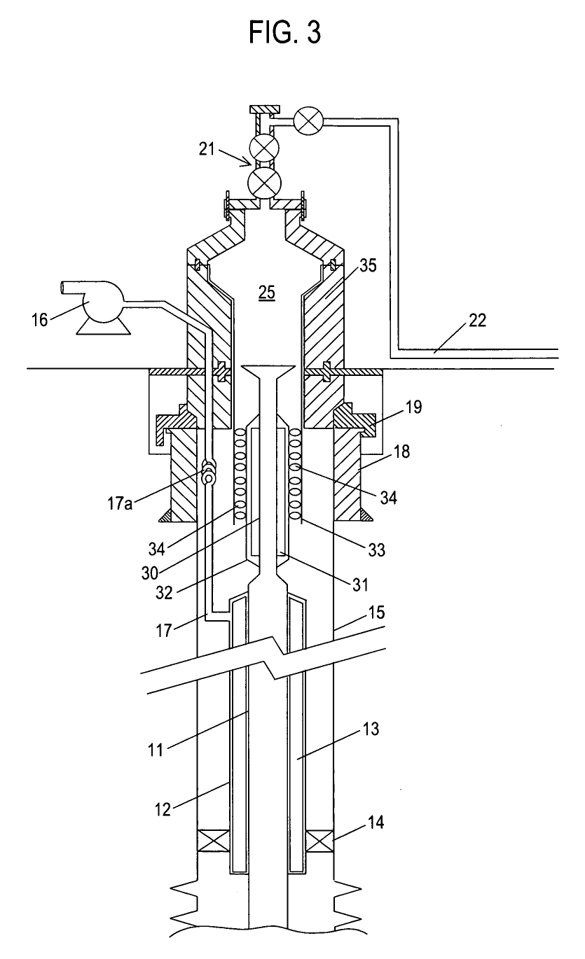

The third embodiment of the inventive double-walled insulated tubular well completion system of the present invention is illustrated in FIG. 3. The embodiment illustrated in FIG. 3 again includes many of the elements described and illustrated in FIG. 1. However, unlike the embodiments of FIGS. 1 and 2, the third embodiment of FIG. 3 includes a below-ground expansion chamber and specially insulated tubing and seals. As shown in FIG. 3, an upper portion 30 of the inner tubing 11 is of lesser diameter than the remaining lower portion of the inner tubing, and said upper portion is surrounded on its outer surface with another insulation layer 31 which is enclosed between said upper portion and a surrounding cylindrical envelope 32 of tubing material. Again here, the insulation may be attached to the inner wall of the envelope rather than the outer wall of the upper portion of the inner tubing. Lower portion 21a of the wellhead includes an expansion tube hanger 35 in the form of a shoulder around the interior surface thereof. The expansion chamber includes a downward extension tube 33 of greater diameter than cylindrical envelope 32 which is located substantially co-axially within the downward extension tube 33. At least one annular sealing spacer 34 is located between the outer surface of the cylindrical envelope 32 and the inner surface of the downward extension tube 33 for preventing fluid from passing downward and reaching the insulation layer 13.

The FIG. 3 embodiment, additionally comprises a vacuum pump 16 connected through conduit 17 to reduce pressure within the portion of the annular volume which contains insulation 13. Conduit 17 includes a curved or helical section 17a to accommodate differential expansion and contraction of different parts of the system.

The bottom of the tubular string may additionally include perforations, as sometimes used in this art.

In addition to the advantageous double-walled insulated tubular well completion systems illustrated and described in conjunction with FIGS. 1-3, above, several methods of installation of such well completion systems are preferred.

In a first method of installation, installation proceeds with inner and outer tubings still separate, and without any packer, as follows:
A. Wellhead lower portion 21a is installed in place;
B. Insert into the lower portion of the wellhead a first double-walled tubing section, which has the bottoms of the inner and outer tubes sealed together;
C. Lower the tubing into the well casing to about its proper position;
D. Prepare the next inner tubing section in a rig over the well;
E. Screw connect the next inner tubing section to the inner tubing section already installed;
F. Place the next outer tubing section around the next inner tubing section in the rig;
G. Screw connect the next outer tubing section to the section of outer tubing already installed;
H. Repeat steps D through G until the desired length of double-walled tubing has been installed within the well;
I. Position the top ends of the double tubings within the lower wellhead portion, and lock the outer tubing in the tubing hanger;
J. Install the remainder of the wellhead 21 and connect a tube or control line to connect the annular space between the inner and outer tubing to a vacuum pump for reducing pressure within the annular space to improve thermal performance of the installation;
K. Connect the fluid lines to the wellhead.

In a second method of installation, commencing with separate inner and outer tubing sections, and a packer:
A¹. Wellhead lower portion 21a is installed in place;
B¹. Insert into the lower portion of the wellhead a first double-walled tubing section, which has the bottoms of the inner and outer tubes sealed together;
C¹. Lower the tubing into the well casing to about its proper position;
D¹. Prepare the next inner tubing section in a rig over the well;
E¹. Screw connect the next inner tubing section to the inner tubing section already installed;
F¹. Place the next outer tubing section around the next inner tubing section in the rig;
G¹. Screw connect the next outer tubing section to the section of outer tubing already installed;
H¹. Repeat steps D¹ through G¹ until the desired length of double-walled tubing has been installed within the well;
I¹. After a packer has been installed, place the inner and outer tubing strings under tension;
J¹. Position the top ends of the double tubings within the lower wellhead portion, and lock the outer tubing in the tubing hanger;
K¹. Install the remainder of the wellhead and connect a tube or control line to the annular space between the inner and outer tubing to a vacuum pump for reducing pressure within the annular space to improve thermal performance of the insulation;
L¹. Connect the fluid lines to the wellhead.

And in a third method of installation, where a packer, outer tubing section and inner tubing section have already been assembled over one another into a first or bottommost tubing section:
A¹¹. Wellhead lower portion 21a is installed in place;
B¹¹. Insert into the lower portion of the wellhead a first double-walled tubing section, which has the bottoms of the inner and outer tubes sealed together;
C¹¹. Lower the tubing into the well casing to about its proper position;
D¹¹. Prepare the next inner tubing section in a rig over the well;
E¹¹. Screw connect the next inner tubing section to the inner tubing section already installed;
F¹¹. Screw connect the next outer tubing section to the section of outer tubing already installed;
G¹¹. Repeat steps D¹¹ through F¹¹ until the desired length of double-walled tubing has been installed within the well;
H¹¹. After a packer has been installed, place the inner and outer tubing strings under tension;
I¹¹. Position the top ends of the double tubings within the lower wellhead portion, and lock the outer tubing in the tubing hanger;
J¹¹. Install the remainder of the wellhead 21 and connect a tube or control line to the annular space between the inner and outer tubing to a vacuum pump for reducing pressure within the annular space to improve thermal performance of the insulation;
K¹¹. Connect the fluid lines to the wellhead.

In a fourth or alternate method, instead of substantially rigid double-walled tubing sections connected by threaded joints, the insulated double-walled tubing may be of the flexible type which is already prepared in a coil or on a reel, spool or the like. The insulation is already in the space between the inner and outer flexible tubings. Once the bottom ends of the inner and outer tubings have been sealed together, the bottom end may be inserted through the lower portion 21a of the wellhead, and any desired length of the double-walled tubing string fit or inserted into a well casing. When a sufficient length of such a flexible double-walled tubing string has been inserted into the well casing, the top end of that string may be connected to the wellhead in the same manner as the rigid strings are so connected, as described above.

Thus in this fourth method of installation, installation proceeds with a flexible inner and outer tubing as follows:
A⁴. Wellhead lower portion 21a is installed in place;
B⁴. Seal together the leading or bottom ends of the inner and outer flexible tubing;
C⁴. Insert into the lower portion of the wellhead the sealed leading or bottom end of the insulated double-walled flexible tubing;
D⁴. Lower the flexible tubing into the well casing to about its proper position;
E⁴. Position the top ends of the double tubings within the lower wellhead portion, and lock the outer tubing in the tubing hanger;
F⁴. Install the remainder of the wellhead 21 and connect a tube or control line to connect the annular space between the inner and outer tubing to a vacuum pump for reducing pressure within the annular space to improve thermal performance of the installation;
G⁴. Connect the fluid lines to the wellhead.

While the advantages of the present invention have been illustrated and explained in specific embodiments herein, those skilled in this art will understand that various modifications of the advantageous well completion systems of the present invention may be made without departing from the scope and spirit of the invention as stated in the following claims.

What is claimed is:

1. An insulated double-walled well completion tubing system comprising:
an inner tubing;
an outer tubing for insertion into a well casing;
said inner tubing being within said outer tubing, and sealed together with the outer tubing at bottom ends of the co-axial inner and outer tubings, the inner and outer tubings defining a generally annular volume;
an insulation layer in the annular volume;
a wellhead connected to the top end of the outer tubing;
a source of heated fluid connected to the wellhead;
at least one sealing spacer in said annular volume located above the insulation layer and below the upper end of the inner tubing, for preventing fluid from passing downward through the annular volume and reaching the insulation;
the wellhead enclosing a space of sufficient dimensions to accommodate the upper end of the inner tubing at any temperature thereof.

2. The well completion system of claim 1 wherein the inner and outer tubings are substantially co-axial.

3. The well completion system of claim 1, additionally comprising a vacuum pump connected to reduce the pressure within the portion of the annular volume which contains the insulation.

4. The well completion system of claim 1, wherein the insulation layer in the annular volume is connected to one of the outer surface of the inner tubing or the inner surface of the outer tubing.

5. The well completion system of claim 1, additionally comprising a packer surrounding the outside surface of the outer tubing near the lower end thereof, for maintaining spacing between said lower end and a well casing.

6. The well completion system of claim 1, additionally comprising an expansion chamber located below the wellhead and extending the vertical dimension of the space enclosed by the wellhead.

7. The well completion system of claim 1, wherein the expansion chamber is above ground level.

8. The well completion system of claim 1, wherein the expansion chamber is below ground level.

9. The well completion system of claim 1, wherein the wellhead includes a lower portion which includes a tubing hanger on the interior surface of said lower portion.

10. The well completion system of claim 9, wherein the tubing hanger comprises a shoulder in said interior surface.

11. The well completion system of claim 1, additionally comprising:
an expansion chamber extending the vertical dimension of the space enclosed by the wellhead, said expansion chamber located below the wellhead;
wherein an upper portion of the inner tubing is of lesser diameter than the remaining lower portion of the inner tubing, and said upper portion is surrounded on its outer surface with another insulation layer which is enclosed between said upper portion and a surrounding cylindrical envelope of tubing material;
a downward extension tube of greater diameter than said cylindrical envelope which is located substantially co-axially within said downward extension tube;
and at least one annular sealing spacer is located between the outer surface of the cylindrical envelope and the inner surface of the downward extension tube for preventing fluid from passing downward and reaching the other insulation layer.

12. The well completion system of claim 11, wherein the wellhead includes a lower portion which includes an extension tubing hanger on the interior surface of the lower portion, and the downward extension tube is supported by said extension tubing hanger.

13. The well completion system of claim 3, wherein the vacuum pump is connected by a curved conduit capable of expanding and contracting to accommodate differential changes in the lengths of the inner and outer tubings.

14. An insulated double-walled well completion tubing system comprising:
a continuous, flexible, coilable, insulated, double-walled tubing, comprising
an inner flexible tubing;
an outer flexible tubing for insertion into a well casing;
said inner tubing being within said outer tubing, and sealed together with the outer tubing at bottom ends of the co-axial inner and outer tubings, the inner and outer tubings defining a generally annular volume;
an insulation layer in the annular volume;
a wellhead connected to the top end of the outer flexible tubing;
a source of heated fluid connected to the wellhead;
at least one sealing spacer in said annular volume located above the insulation layer and below the upper end of the inner tubing, for preventing fluid from passing downward through the annular volume and reaching the insulation;
the wellhead enclosing a space of sufficient dimensions to accommodate the upper end of the inner tubing at any temperature thereof.

15. A method of assembling and installing an insulated double-walled well completion system of claim 1, said method comprising:
(a) connect a lower portion of a wellhead to the top of a well casing;
(b) insert into the lower portion of the wellhead a first, bottommost double-walled tubing section, wherein the bottoms of the inner and outer tubes are sealed together;
(c) lower the first tubing section into the well casing;
(d) mount a next inner tubing section in a rig over the well casing;
(e) connect the next inner tubing section to the inner tubing section of the first or already installed section;
(f) place the next outer tubing section around the next inner tubing section in the rig;
(g) connect the next outer tubing section to the first or already installed section of outer tubing;
(h) repeat steps (d) through (g) until a desired string length of double-walled tubing has been installed within the well casing;
(i) position the top ends of the double-walled tubings within the lower portion of the wellhead, and lock the outer tubing in a tubing hanger in the wellhead;
(j) connect the remainder of the wellhead to the lower wellhead portion;
(k) connect a conduit to the annular space between the inner and outer tubes to a vacuum pump for reducing pressure within the annular space; and
(l) connect a fluid line to the wellhead.

16. The method of claim 15 wherein the ends of tubing sections are screw threaded and connected together by threaded joints.

17. The method of claim 15 wherein a packer ring is placed around the outside surface of the lower end of the outer tubing in the lowermost tubular section before it is inserted into the lower portion of the wellhead.

18. The method of claim 15 wherein insulation is located between the inner and outer tubing before at least the outer tubing is placed around the inner tubing.

19. The method of claim 15 additionally comprising connecting an expansion section on top of the lower wellhead portion before connecting the remainder of the wellhead thereto.

20. A method of assembling and installing an insulated double-walled well completion system of claim 12, said method comprising:
(a) connect a lower portion of a wellhead to the top of a well casing;
(b) insert into the lower portion of the wellhead a first, bottommost double-walled tubing section, wherein the bottoms of the inner and outer tubes are sealed together;
(c) lower the first tubing section into the well casing;
(d) mount a next inner tubing section in a rig over the well casing;
(e) connect the next inner tubing section to the inner tubing section of the first or already installed section;
(f) place the next outer tubing section around the next inner tubing section in the rig;
(g) connect the next outer tubing section to the first or already installed section of outer tubing;
(h) repeat steps (d) through (g) until a desired string length of double-walled tubing has been installed within the well casing;
(i) position the top ends of the double-walled tubings within the lower portion of the wellhead, and lock the outer tubing in a tubing hanger in the wellhead;
(j) connect the remainder of the wellhead to the lower wellhead portion;
(k) connect a conduit to the annular space between the inner and outer tubes to a vacuum pump for reducing pressure within the annular space;
(l) connect a fluid line to the wellhead;
wherein the topmost section of the inner tubing includes the upper portion of lesser diameter; and
(m) connecting a downward extension tube supported by an extension tube hanger in the lower wellhead portion.

21. A method of assembling and installing an insulated double-walled well completion system of claim 14, said method comprising:
(a) connect a lower portion of a wellhead to the top of a well casing;
(b) seal together the leading or bottom ends of the inner and outer flexible tubings;
(c) insert into the lower portion of the wellhead the sealed leading or bottom end of the insulated double-walled tubing section,
(d) lower the continuous flexible tubing into the well casing;
(e) position the top ends of the flexible double-walled tubings within the lower portion of the wellhead, and lock the outer tubing in a tubing hanger in the wellhead;
(f) connect the remainder of the wellhead to the lower wellhead portion;
(g) connect a conduit to the annular space between the inner and outer tubing, and to a vacuum pump for reducing pressure within the annular space; and
(h) connect a fluid line to the wellhead.

22. The method of claim 15 wherein steps (a) through (l) are performed in that order.

23. The method of claim 20 wherein steps (a) through (l) are performed in that order.

24. The method of claim 21 wherein steps (a) through (h) are performed in that order.
